(19) United States
(12) Patent Application Publication
(10) Pub. No.: US 2024/0424488 A1
(43) Pub. Date: Dec. 26, 2024

(54) High-Entropy Metal-Organic Frameworks

(71) Applicant: National Technology & Engineering Solutions of Sandia, LLC, Albuquerque, NM (US)

(72) Inventors: Dorina F. Sava Gallis, Albuquerque, NM (US); Jacob Harvey, Rio Rancho, NM (US); Dayton Jonathan Vogel, Sioux Falls, SD (US); Ronald Sikma, Hamilton, OH (US)

(21) Appl. No.: 18/800,539

(22) Filed: Aug. 12, 2024

Related U.S. Application Data
(63) Continuation-in-part of application No. 18/080,044, filed on Dec. 13, 2022.
Application No. 18/080,044 is a continuation-in-part of application No. 17/479,710, filed on Sep. 20, 2021, now Pat. No. 11,767,468.
(60) Provisional application No. 63/086,419, filed on Oct. 1, 2020.

(51) Int. Cl. B01J 31/16

(52) U.S. Cl. CPC B01J 31/1691; B01J 2231/625; B01J 2531/0211; B01J 2531/38; B01J 2531/39

(57) ABSTRACT

Highly stable high-entropy metal-organic frameworks (HEMOFs) are derived from polynuclear metal clusters, incorporating significant levels of all rare-earth metals without segregation. As an example, HEMOFs comprising nonanuclear metal clusters of rare-earth element ions with similar size and coordination chemistry connected by 1,2,4,5-tetrakis (4-carboxyphenyl) benzene linkers was developed, providing a metal-organic framework with high internal surface area and accessible Lewis acid sites. This new class of HEMOFs enables the development of multifunctional materials with tailored properties for a wide range of applications, including in catalysis. For example, these HEMOFs are highly active for CO₂ fixation under mild conditions and short reaction times, outperforming existing heterogeneous catalysts.

### CROSS-REFERENCE TO RELATED APPLICATIONS

This application is a continuation-in-part of U.S. application Ser. No. 18/080,044, filed Dec. 13, 2022; which is a continuation-in-part of U.S. application Ser. No. 17/479,710, filed Sep. 20, 2021, now U.S. Pat. No. 11,767,468; which claims the benefit of U.S. Provisional Application No. 63/086,419, filed Oct. 1, 2020, all of which are incorporated herein by reference.

### FEDERALLY SPONSORED RESEARCH AND DEVELOPMENT

This invention was made with Government support under Contract No. DE-NA0003525 awarded by the United States Department of Energy/National Nuclear Security Administration. The Government has certain rights in the invention.

### BACKGROUND OF THE INVENTION

As the technological landscape continues to evolve, innovative advanced materials must be rationally developed to address new challenges on-demand. In particular, closing the carbon cycle via carbon capture and utilization (CCU) is at the forefront of scientific research as a technical grand challenge. Among the many possible approaches, conversion of CO₂ into value-added products, such as cyclic carbonates, could be an integral part of the CCU toolkit owing to reduced energy input and highly advantageous recycling paradigm. Cyclic carbonates serve as important intermediates in the production of polycarbonates and as green solvents, highlighting the dual environmental and economic benefits of this transformation. However, the development of highly efficient, selective, and stable catalysts remains a significant challenge that needs to be addressed.

In recent years, high-entropy materials (HEMs), including metal alloys and metal oxides, have demonstrated emergent properties and garnered increased attention. See Y. Sun and S. Dai, Sci. Adv. 7, eabg1600 (2021); S. S. Aamlid et al., J. Am. Chem. Soc. 145, 5991 (2023); C. M. Rost et al., Nat. Commun. 6, 8485 (2015); and X. Wang et al., J. Mater. Chem. A 9, 663 (2021). HEMs are crystalline materials containing approximately equimolar quantities of 5 or more metals, which are distributed randomly across identical crystallographic positions. These materials benefit from high configurational entropy (S_{conf}) imparted by their multi-metallic compositions, giving rise to superior materials with high mechanical strength, remarkable thermal stability, and tunable electronic and magnetic properties. HEMs harness the properties of diverse metal centers to provide enhanced chemical properties, including oxidation resistance and catalytic activity, through synergistic effects that are not achievable in traditional materials. See Y. Sun and S. Dai, Sci. Adv. 7, eabg1600 (2021); A. Amiri and R. Shahbazian-Yassar, J. Mater. Chem. A 9, 782 (2021); Y. Chen et al., ACS Mater. Lett. 3, 160 (2021); and J.-W. Yeh and S.-J. Lin, J. Mater. Res. 33, 3129 (2018). As such, this is an emerging research area that will continue to produce new breakthroughs in performance as the field matures. HEM catalysts have shown significant promise for a diverse array of chemical transformations, including the hydrogen evolution reaction, the oxygen evolution reaction, CO₂ reduction, N₂ fixation, dry reforming of methane, and various organic reactions. See F. Xing et al., Nat. Commun. 13, 5065 (2022); S. Nellaiappan et al., ACS Catal. 10, 3658 (2020); and H. Chen et al., ACS Mater. Lett. 1, 83 (2019). However, one drawback of traditional HEM catalysts is that they are nonporous, burying potential reactive sites within the bulk structure and limiting catalysis to surface sites. Given this disadvantage, designing HEMs with intrinsic porosity could open the door to improved atom efficiency and enhanced reactivity while maintaining the many benefits of high configurational entropy. Designing porosity into HEMs could additionally enhance their interactions with gas-phase substrates such as CO₂, which is a primary driver of man-made climate change.

In the realm of porous materials, metal-organic frameworks (MOFs) display unsurpassed performance and tunability. MOFs are hybrid organic-inorganic materials constructed from metal ions or clusters linked through organic molecules with two or more metal binding groups to form polymeric crystalline structures. See H. Furukawa et al., Science 341, 1230444 (2013). These materials have been studied for a broad range of applications and have shown immense promise as catalysts for numerous reactions, including for the conversion of CO² into value-added products. See D. Narváez-Celada and A. S. Varela, J. Mater. Chem. A 10, 5899 (2022); and F. Guo and X. Zhang, Dalton Trans. 49, 9935 (2020). Although MOFs have been shown to be good catalysts for the reaction of CO₂ with epoxides to produce cyclic carbonates, they typically require high pressures, elevated temperatures, and/or long reaction times in order to be effective.

The combination of two or more metals into a single MOF structure has been shown to lead to synergistic effects; for example, heterometallic MOFs have demonstrated superior catalytic activity and stability compared to monometallic analogues. See R. E. Sikma et al., J. Am. Chem. Soc. 146, 5715 (2024); and S. Abednatanzi et al., Chem. Soc. Rev. 48, 2535 (2019). Many bimetallic and trimetallic systems have been studied, and MOFs containing as many as 10 unique metals have been reported, but the ratios between different metals in these materials are often highly variable, limiting the impact of the targeted functionality arising from cooperative metal interactions. Furthermore, high-entropy MOFs (HEMOFs), which contain 5 or more distinct metals in near-equimolar ratios, remain rare in literature, and the concept of maximizing configurational entropy in MOFs has only rarely been invoked. See L. J. Wang et al., Inorg. Chem. 53, 5881 (2014); W. Xu et al., Chem., Int. Ed. 58, 5018 (2019); Y. Ma et al., Adv. Mater. 33, 2101342 (2021); X. Zhao et al., J. Mater. Chem. A 7, 26238 (2019); Y. Sun et al., Carbon Energy 5, e263 (2023); and Z. Li et al., Adv. Funct. Mater. 33, 2307369 (2023). Most current examples of HEMOFs rely on single metal ions or rod-like metal ion chains as the inorganic building units, while many of the most stable and tunable MOFs are constructed from discrete, polynuclear metal clusters. See W. Xu et al., Chem., Int. Ed. 58, 5018 (2019); Y. Ma et al., Adv. Mater. 33, 2101342 (2021); X. Zhao et al., J. Mater. Chem. A 7, 26238 (2019); Y. Sun et al., Carbon Energy 5, e263 (2023); L. Feng et al., Adv. Mater. 32, 2004414 (2020); and S. Yuan et al., Adv. Mater. 30, 1704303 (2018). In this context, expanding the materials design space to allow the incorporation of significant levels of elements without segregation within stable, polynuclear-cluster based MOFs would represent an important advancement in the field, enabling a breakthrough towards realizing the full potential of heterometallic MOFs. Furthermore, a concomitant implementation of experimental-complementary computational tools is imperative to effectively enable control over the structure-property relationships in HEMOFs.

### SUMMARY OF THE INVENTION

The present invention is directed to a high-entropy metal-organic framework, comprising a plurality of polynuclear metal clusters, each polynuclear metal cluster comprising five or more rare-earth metals; wherein the rare-earth metals are present in the high-entropy metal-organic framework in approximately equimolar ratios according to −Σxᵢ ln(xᵢ)≥1.5, where xᵢ is the mole fraction of each rare-earth metal i relative to a total rare-earth metal content; and wherein the plurality of polynuclear metal clusters are connected by carboxylic acid-based linkers. The invention is further directed to a method for the catalytic conversion of carbon dioxide, comprising reacting carbon dioxide with an epoxide in the presence of a high-entropy metal-organic framework catalyst, thereby yielding a cyclic carbonate as a reaction product.

The invention provides a family of tailorable HEMOF catalyst materials derived from polynuclear rare-earth metal clusters. Compositions incorporating up to 15 unique metals have been achieved. Analytical techniques and computational modeling demonstrated that the metals in these HEMOFs are well mixed at the cluster level, maximizing their configurational entropy. As an example, a catalyst comprising metal clusters connected by 1,2,4,5-tetrakis(4-carboxyphenyl) benzene linkers (M-TCPB) demonstrated outstanding catalytic activity for the epoxidation of CO₂. These high-entropy materials enable the development of next-generation catalysts with enhanced multifunctionality and performance.

### BRIEF DESCRIPTION OF THE DRAWINGS

The detailed description will refer to the following drawings, wherein like elements are referred to by like numbers.

FIG. 1A is a representation of M-TCPB crystal structure highlighting nonanuclear metal cluster of 5 mixed rare-earth elements and 1,2,4,5-tetrakis (4-carboxyphenyl)benzene (TCPB) linkers. FIG. 1B shows powder X-ray diffraction (PXRD) patterns for each M-TCPB material synthesized. FIG. 1C shows N₂ adsorption (closed circles) and desorption (open circles) isotherms collected at 77 K for the monometallic and heteronuclear HEMOFs synthesized. FIG. 1D shows a scanning electron microscope (SEM) image and corresponding energy-dispersive X-ray spectroscopy (EDX) maps for each metal in 5M-TCPB. FIG. 1E shows a SEM image and corresponding EDX maps for each metal in 15M-TCPB.

FIG. 2 shows experimental data (black dots), calculated envelopes (lines), and individual fits for Eu 3d, Y 3d, and Yb 4d X-ray photoelectron spectroscopy (XPS) spectra of M-TCPB materials, with peak positions denoted by dotted black lines and labeled numerically; experimental data (black dots) and envelopes (lines) for F 1s XPS spectra of M-TCPB materials, with peak position of Eu-TCPB indicated by dotted black line; inset: diagram demonstrating expected changes in metal and fluorine binding energies (B.E.s) based on metal composition (M1 vs. M2, M1≠M2).

FIG. 3A shows a high-angle angular dark-field/scanning transmission electron microscope (HAADF STEM) image of 5M-TCPB with crystal structure shown for reference and corresponding EDX maps demonstrating the presence of all 5 metals in each cluster. FIG. 3B shows a machine learning analysis of 5M-TCPB EDX data showing that the data can be fit using only 2 components, verifying that the individual metal clusters have essentially the same composition. FIG. 3C shows a HAADF STEM image of 15M-TCPB and corresponding EDX maps showing a homogeneous distribution of metals across the nm length scale. See P. G. Kotula and M. R. Keenan, Microsc. Microanal. 12, 538 (2006); and M. R. Keenan and P. G. Kotula, Appl. Surf. Sci. 231-232, 240 (2004).

FIG. 4 illustrates cycloaddition of CO₂ with 4-chlorostyrene oxide catalyzed by M-TCPB.

FIG. 5 shows spin polarized d-orbital projected density of states near the band edges localized on rare earth metals in mono- and heterometallic MOF compositions with corresponding cluster models overlaid; regions associated with the valence band (VB) and conduction band (CB) are highlighted by dashed boxes.

FIG. 6A shows the total density-of-states (DOS) contribution of each metal and the normalized total p-orbital DOS for spin polarized projected DOS near the band edges in the 5M cluster model. FIG. 6B shows the individual contributions of ligand atoms to the total p-orbital DOS.

FIG. 7 is an atomistic model of the 5M heterometallic MOF cluster, shown without H₂O for clarity, comprised of Y, Eu, Gd, Er, and Yb rare earth metals; and F, O, C, H bridging atoms.

### DETAILED DESCRIPTION OF THE INVENTION

The present invention is directed to the synthesis of highly stable HEMOFs derived from polynuclear metal clusters, incorporating significant levels of all rare-earth metals without segregation. As an example, a materials family derived from rare-earth element (REE) ions with similar size and coordination chemistry, and 1,2,4,5-tetrakis (4-carboxyphenyl) benzene (TCPB) was developed, directing the formation of a framework (M-TCPB, M=metal) that has high internal surface area and nonanuclear metal clusters with accessible Lewis acid sites. This materials platform offers exquisite synthetic control and circumvents the need for energy-intensive or specialized synthetic techniques (e.g., thermal shock synthesis), which has been leveraged to develop a series of HEMOFs containing between 5 and up to 15 unique metals in significant proportions. See Y. Yao et al., Matter 4, 2340 (2021). Exceeding the previous record for number of metals included in a single MOF (10), the 15-metal HEMOF of the present invention establishes a new benchmark for compositional complexity and configurational entropy in MOFs. See L. J. Wang et al., Inorg. Chem. 53, 5881 (2014).

A synergistic experimental-computational approach was implemented. A suite of complementary characterization techniques and density functional theory (DFT) calculations was used to carefully examine the metal distributions in these materials and to demonstrate control over the structure-function interplay. Homogenous metal mixing within individual HEMOF clusters was directly observed by high-resolution scanning transmission electron microscopy coupled with energy-dispersive X-ray spectroscopy (STEM-EDX). Complementary density of states (DOS) calculations demonstrate unique energy shifts within the electronic structure of the materials as the number of metal species included in the metal cluster progresses.

The HEMOF materials of the present invention are permanently porous, display remarkable thermal and chemical stability, and their complex metallic compositions create a rich landscape of potential catalytic sites to effectively promote the cycloaddition of CO₂ and chlorostyrene oxide under mild conditions and short reaction times, outperforming existing heterogeneous catalysts for CO₂ epoxidation. Importantly, the materials design strategy described herein is flexible to allow exploration of a larger number of HEMOF families with related cluster compositions, but with distinct linker sizes and topologies. This, in combination with DFT studies represents a powerful tool towards developing predictive capabilities and reiterates the possibility to selectively combine ligands with polynuclear clusters with predetermined metallic ratios, enabling the direct assessment of the impact of cluster proximity, electronic structure and overall porosity on the catalytic process.

### HEMOF Synthesis and Characterization

In principle, the S_{conf} is large enough in HEMs to become the driving factor governing their formation at high temperatures, and the materials are often said to be “entropy stabilized.” However, the term “high-entropy” has been applied more broadly to systems containing 5 or more metals that do not strictly display entropy stabilization, while maintaining the requirement that the metals exist in near-equimolar ratios. See S. S. Aamlid et al., J. Am. Chem. Soc. 145, 5991 (2023). The ideal configurational entropy of HEMs can be approximated as

$${S}_{conf} \approx - R \sum {x}_{i} ln ( {x}_{i} ) \qquad ( 1 )$$

where xᵢ is the mole fraction of each metal i relative to the total metal content and R is the ideal gas constant. See Y. Sun and S. Dai, Sci. Adv. 7, eabg1600 (2021); and S. S. Aamlid et al., J. Am. Chem. Soc. 145, 5991 (2023). Based on this equation, S_{conf} is maximized at equimolar ratios, hence the constraint that the metals in HEMs should occur in near-equal proportions. For a 5-metal material, the maximum S_{conf} occurs when xᵢ=0.2, giving a value of 1.61R. One accepted definition of a HEM is a material for which S_{conf} is ≥1.5 R, which requires incorporation of 5 or more metals while allowing for some deviation from equimolar ratios. See S. S. Aamlid et al., J. Am. Chem. Soc. 145, 5991 (2023). This definition can be readily applied to materials with known atomic proportions and is used hereinafter.

MOFs contain large numbers of nonmetal atoms and there are therefore inherent shortcomings in the application of Equation (1) to these materials, but considering the S_{conf} of the metals only was deemed sufficient for comparison between different HEMOFs in the following context. Although MOFs containing ≥5 metals are unlikely to meet every definition of a HEM, a handful of MOFs that meet the HE criteria used herein (i.e., HEMOFs) have been described. See S. S. Aamlid et al., J. Am. Chem. Soc. 145, 5991 (2023); O. F. Dippo and K. S. Vecchio, Scr. Mater. 201, 113974 (2021); L. J. Wang et al., Inorg. Chem. 53, 5881 (2014); W. Xu et al., Chem. Int. Ed. 58, 5018 (2019); Y. Ma et al., Adv. Mater. 33, 2101342 (2021); X. Zhao et al., J. Mater. Chem. A 7, 26238 (2019); Y. Sun et al., Carbon Energy 5, e263 (2023); and Z. Li et al., Adv. Funct. Mater. 33, 2307369 (2023).

Historically, the use of polynuclear metal clusters as building blocks was crucial in the development of MOF reticular chemistry, wherein choice of the appropriate organic linker and synthetic conditions allows precise control over the distances between metal clusters and their 3-dimensional arrangements. See D. J. Tranchemontagne et al., Chem. Soc. Rev. 38, 1257 (2009); M. Eddaoudi et al., Science 295, 469 (2002); R. Freund et al., Angew. Chem., Int. Ed. 60, 23946 (2021); and C. Gropp et al., ACS Cent. Sci. 6, 1255 (2020). The clusters impart stability that is otherwise difficult to achieve, allowing the development of MOFs with exceptional porosity. See H. Furukawa et al., Science 329, 424 (2010). Because close proximity is required for metals to function cooperatively or synergistically, interactions are typically confined to the individual metal clusters in such materials, as adjacent clusters are often too distal to allow them to act in concert. See J. I. Deneff et al., Nat. Commun. 14, 981 (2023). Thus, in order to benefit from a HE configuration, cluster-based HEMOFs must include clusters with a random, homogeneous distribution of at least 5 unique metals. Clusters that contain fewer than 5 metal centers cannot be used to construct viable HEMOFs, and building units with even higher nuclearity (e.g., hexa- or nonanuclear clusters) are preferred.

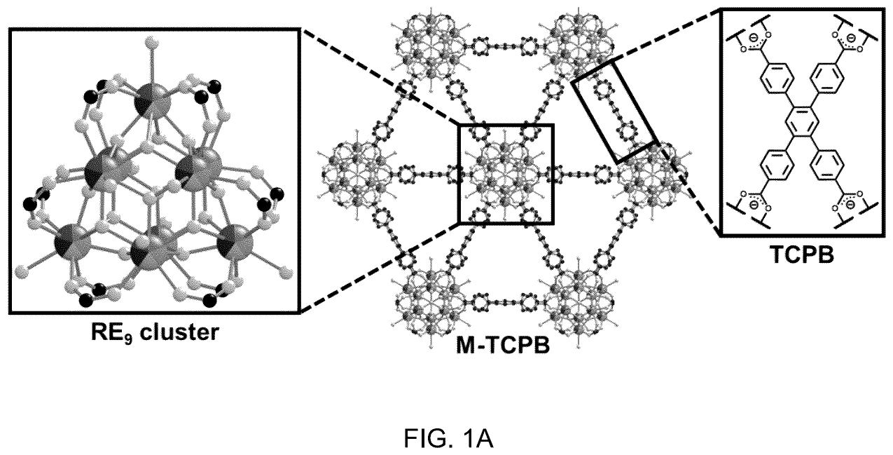

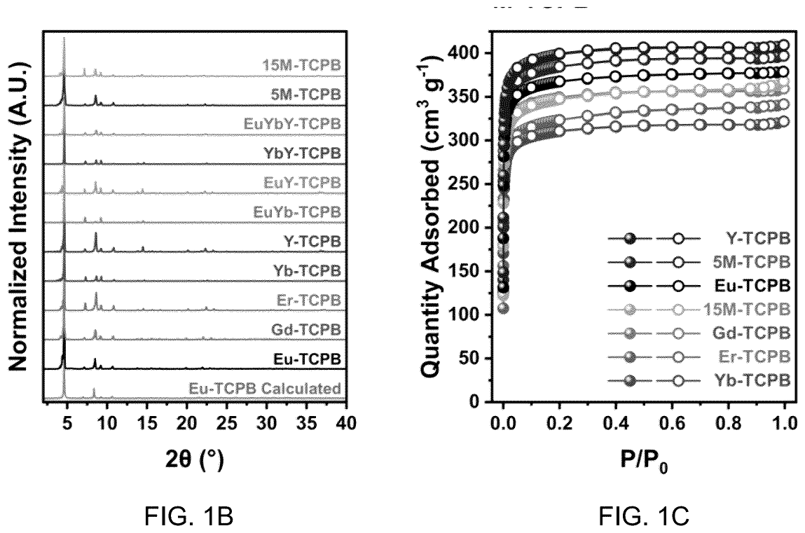

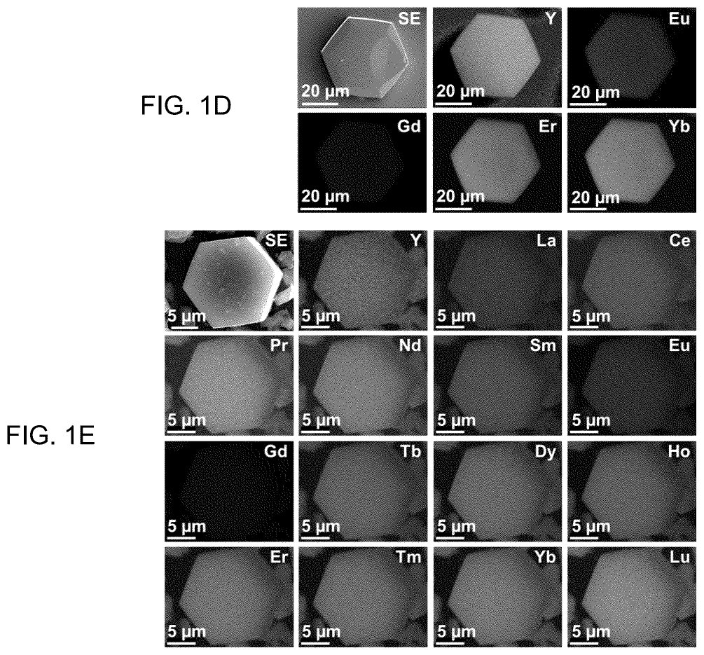

The inorganic building units of M-TCPB are nonanuclear clusters of 3+ rare-earth element (REE) ions that are bridged through 2 μu₃-O²⁻ ligands and 12 μ₃-bridging OH⁻/F⁻ ligands, as shown in FIG. 1A. Fluoride and hydroxide occupy interchangeable crystallographic positions and may exist in variable ratios, but it is noteworthy that these clusters do not form in the absence of a fluoride source. See J. P. Vizuet et al., J. Am. Chem. Soc. 143, 17995 (2021); and M. S. Christian et al., JACS Au 2, 1889 (2022). In this case, F⁻ is derived from the decomposition of a modulator, 2-fluorobenzoic acid (2-FBA). The clusters are capped by 9 terminal H₂O/OH⁻/F⁻ ligands, with the H₂O ligands providing numerous potential open metal sites. The REE clusters are capped by 12 μ₂-bridging carboxylates from tetratopic 1,2,4,5-tetrakis(4-carboxyphenyl)benzene (TCPB) linkers, forming a (4,12)-connected net with triangular channels running parallel to the crystallographic c-axis. M-TCPB can be formed with numerous REE ions, making it an ideal platform for this example. See J. I. Deneff et al., Nat. Commun. 14, 981 (2023); and U.S. patent Ser. No. 17/479,710, which are incorporated herein by reference.

Although TCPB was used in the exemplary M-TCPB MOF, a wide variety of carboxylic acid-based linkers, including di-, tri-, tetra-, or hexacarboxylic acids, can be used with the invention. Exemplary dicarboxylic acids include [1,1′:4′,1″-terphenyl]-4,4″-dicarboxylic acid; [1,1′:4′,1″-terphenyl]-4,4″-dicarboxylic acid-2′,5′-dimethyl; 1,1′-bis(4-carboxyphenyl)-[4,4′-bipryridine]-1,1′-diium; 2′,5′-bis(trifluoromethyl)-[1,1′:4′,1″-terphenyl]-4,4″-dicarboxylic acid; 2,2′-diamino-[1,1′-biphenyl]-4,4′-dicarboxylic acid; 2,3,5,6-tetrafluroterephthalic acid; 2′,3′,5′,6′-tetramethyl-[1,1′:4′,1″-terphenyl]-4,4″-dicarboxylic acid; 2,5-diaminoterephthalic acid; 2,5-dimethylterephthalic acid; 2,2′-methyl-[1,1′:4′,1″-terphenyl]-4,4″-dicarboxylic acid; 2′,5′-dihydroxy-[1,1′:4′,1″-terphenyl]-4,4″-dicarboxylic acid; 2′-amino-[1,1′:4′,1″-terphenyl]-4,4″-dicarboxylic acid; 2-aminoterephthalic acid; 2-bromoterephthalic acid; 2-chloroterephthalic acid; 2-fluroterephthalic acid; 2-hydroxyterepthalic acid; 2-iodoterepthalic acid; 2-methoxyterephthalic acid; 2-methyl-1,4-benzenedicarboxylic acid; 2-nitroterephthalic acid; 3,3″-diamino-[1,1′:4′,1″-terphenyl]-4,4″-dicarboxylic acid; 3,3″-dihydroxy-[1,1′:4′,1″-terphenyl]-4,4″-dicarboxylic acid; 3,3′-diamino-[1,1′-biphenyl]-4,4′-dicarboxylic acid; 3,5-dihydroxyterephthalic acid; 3-amino-[1,1′-biphenyl]-4,4′-dicarboxylic acid; 4,4′-(diazene-1,2-diyl)dibenzoic acid; 4,4′-(anthracene-9,10-diyl) dibenzoic acid; terephthalic acid; and tetrathiafulvalene dicarboxylate. Exemplary tricarboxylic acids include [1,1′:3′,1″-terphenyl]-4,4″-dicarboxylic acid, 2′-amino-5′-(4-carboxyphenyl); [1,1′:3′,1″-terphenyl]-4,4″-dicarboxylic acid, 2′-amino-5′-(4-carboxyphenyl); 1,3,5-tris(4-carboxyphenyl ethynyl)benzene; 2,2′,2″-nitriloacetic acid; 3,3″-diamino-5′-(3-amino-4-carboxyphenyl)-[1,1′:3′,1″-terphenyl)-4,4″-dicarboxylic acid; 4,4′,4″-(benzene-1,3,5-triyltris(ethyne-2,1-diyl))tribenzoic acid; 4′,4″′,4″″′-(1,3,5-triazine-2,4,6-triyl)tris(([1′,1′-biphenyl]-4-carboxylic acid)); 5′-(4-carboxyphenyl)-[1,1′:3′,1″-terphenyl]-4,4″-dicarboxylic acid; 5″-(4′-carboxy-[1,1′-biphenyl]-4-yl)-[1,1′:4′,1″:3″,1″′,4′″, ′″″-quinquephenyl]-4,4″″-dicarboxylic acid; 6,6′,6″-(2,4,6-trimethylbenzene-1,3,5-triyl)tris(2-napthoic acid); benzene-1,3,5-tricarboxylic acid; and trimellitic acid. Exemplary tetracarboxylic acids include [1,1′:4′,1″]terphenyl-3,3″,5,5″-tetracarboxylic acid; 2′-amino-[1,1′:4′,1″-terphenyl]-3,3″,5,5″-tetracarboxylic acid; 4,4′,4″,4′″-(benzene-1,2,4,5-tetrayltetrakis(ethyne-2,1-diyl))tetrabenzoic acid; 4,4′,4″,4′″-(pyrene-1,3,6,8-tetrayltetrakis(ethyne-2,1-diyl))tetrabenzoic acid; 4,4′,4″,4″′[1,1′-biphenyl]-4,4′-diyllbis(azanetriyl)tetrabenzoic acid; and 5′,5″-bis(4-carboxyphenyl)-[1,1′:3′,1″:3″,1″′-quartephenyl]-4,4′″-dicarboxylic acid. Exemplary hexacarboxylic acids include 5″-(3′,5′-dicarboxy-[1,1′-biphenyl]-4-yl)-[1,1′:4′,1″:3″,1″′:4″′,1″″-quinquephenyl]-3,3″″,5,5″″-tetracarboxylic acid; and 5′,5″′-bis(4-carboxyphenyl)-5″-(4,4″-dicarboxy-[1,1′:3′,1″-terphenyl]-5′-yl)-[1,1′:3′,1″:3′,1″′:3″′,1″″-quinquephenyl]-4,4″″-dicarboxylic acid.

Synthesis of heterometallic MOFs often requires judicious choice of metals, and REE ions display superior compatibility with one another in comparison to other classes of metals (e.g., transition metals). See D. Alezi et al., J. Am. Chem. Soc. 137, 5421 (2015); X. Rao et al., J. Am. Chem. Soc. 135, 15559 (2013); X. Zeng et al., Anal. Chem. 92, 2097 (2020); Y. Zhao and D. Li, J. Mater. Chem. C 8, 12739 (2020); and S. G. Dunning et al., Chem. 2, 579 (2017). There are 17 REES, including the lanthanides (lanthanum, cerium, praseodymium, neodymium, promethium, samarium, europium, gadolinium, terbium, dysprosium, holmium, erbium, thulium, ytterbium, and lutetium), yttrium, and scandium. Of these 17 elements, 15 were deemed viable for this example, as shown in Table 1. Promethium was eliminated due to its radioactivity, while scandium was excluded due to its smaller ionic radius relative to the other REEs. Because M-TCPB is only known to form with 3+ metals, REEs in the 3+ oxidation state were used exclusively.

To synthesize the M-TCPBs, metal salt(s) (0.069 mmol total metal, all metals equimolar), TCPB (11.0 mg, 0.020 mmol), and 2-fluorobenzoic acid (1.68 g, 12.0 mmol) were dissolved in 7.8 mL of dimethylformamide (DMF) in a 20 mL scintillation vial, followed by the addition of 0.60 mL nitric acid (3.5 M in DMF). The vial was capped and heated to 115° C. for 72 h, giving M-TCPB as colorless or off-white hexagonal plates. Metal salts used in the synthesis of the M-TCPB materials were: Y(NO₃)₃·6H₂O, La(NO₃)₃·6H₂O, Ce(NO₃)₃·6H₂O, Pr(NO₃)₃·6H₂O, Nd(NO₃)₃·6H₂O, SmCl₃·6H₂O, EuCl₃·6H₂O, Gd(NO₃)₃·6H₂O, Tb(NO₃)₃·5H₂O, DyCl₃·6H₂O, HoCl₃·6H₂O, Er(NO₃)₃·5H₂O, TmCl₃·6H₂O, Yb(NO₃)₃·5H₂O, and Lu(NO₃)₃·xH₂O.

In order to assess the viability of forming HEM-TCPB, a 5-metal composition with Eu, Gd, Er, Yb, and Y was initially targeted. Direct synthesis was attempted from solutions containing equimolar ratios of these metals (from either chloride or nitrate salts). Powder X-ray diffraction (PXRD) confirmed the formation of the desired M-TCPB material, denoted as 5M-TCPB, with high crystallinity and phase purity, as shown in FIG. 1B. N₂ sorption analysis of an activated sample at 77 K confirmed that 5M-TCPB is permanently porous, with a Brunauer-Emmett-Teller (BET) surface area of 1520 m² g⁻¹, as shown in FIG. 1C. Scanning electron microscopy coupled with energy-dispersive X-ray spectroscopy (SEM/EDX) revealed a homogeneous distribution of all 5 metals across individual crystals and between different crystals, as shown in FIG. 1D. A 5M-TCPB sample was digested and analyzed by ICP-MS in order to determine the precise molar ratios of the metals, and it was found that each individual metal was incorporated in a significant proportion (Table 1). Between the lanthanides, the heavier (smaller) ions were incorporated somewhat preferentially, while the percentage of Y in the MOF was found to be higher than the input ratio. The larger than expected amount of Y was attributed to its higher reactivity as the only transition metal in the series. Despite some variation from the ideal equimolar metal ratios, the S_{conf} of 5M-TCPB was calculated as 1.54R using Equation (1), qualifying the material as a successful example of a HEMOF.

To test the limits of the HE approach to MOF design, direct synthesis of M-TCPB containing each of the 15 metals identified in Table 1 was attempted. The reaction conditions were identical to the conditions used to generate 5M-TCPB, with the exception of the metals used. Crystals with the same morphology as 5M-TCPB were obtained, and PXRD confirmed the formation of a phase-pure M-TCPB material, denoted as 15M-TCPB in FIG. 1B. SEM/EDX confirmed incorporation of each of the 15 metals in significant quantities, with a homogeneous distribution of the metals across the single crystal length scale and between crystals, as shown in FIG. 1E. It should be noted, however, that each nonanuclear cluster can contain a maximum of 9 different metals, necessitating some compositional variation between different metal clusters. ICP-MS analysis of a digested sample revealed that the lanthanides each accounted for ca. 3.7-10.0% of the total metal content, while Y accounted for 14.3%, as shown in Table 1. The results agree well with the percentages determined for 5M-TCPB, with smaller lanthanides generally favored over larger ones and Y favored over the lanthanides. To the best of the inventors' knowledge, 15 is the largest number of individual metals ever incorporated into a single MOF structure. The S_{conf} of 15M-TCPB was calculated as 2.63R, far exceeding the value for 5M-TCPB. This pushes the boundaries of the HEMOFs concept, demonstrating that configurational entropy of M-TCPB can be maximized over a vast compositional space. Notably, HE M-TCPB materials with 6-14 unique REE metals were also successfully obtained by direct synthesis according to PXRD data.

TABLE 1
REEs incorporated into HEMOFs, their ionic radii (3+ charge, 8-
coordinate), and their atomic percentages in 5M-TCPB and 15M-TCPB as a fraction
of total metal content. See R. D. Shannon, Acta Crystallogr. A 32, 751 (1976).

| Rare-Earth Element | Atomic # | rᵢₒₙ [Å] | 5M-TCPB Atom %^{a)} | 15M-TCPB Atom %^{a)} |
|---|---|---|---|---|
| Y | 39 | 1.019 | 33.2 | 14.3 |
| La | 57 | 1.16 | — | 5.06 |
| Ce | 58 | 1.143 | — | 4.34 |
| Pr | 59 | 1.126 | — | 4.11 |
| Nd | 60 | 1.109 | — | 3.78 |
| Sm | 62 | 1.079 | — | 4.04 |
| Eu | 63 | 1.066 | 11.3 | 4.55 |
| Gd | 64 | 1.053 | 13.5 | 5.51 |
| Tb | 65 | 1.04 | — | 5.74 |
| Dy | 66 | 1.027 | — | 6.61 |
| Ho | 67 | 1.015 | — | 7.16 |
| Er | 68 | 1.004 | 18.5 | 7.87 |
| Tm | 69 | 0.994 | — | 8.66 |
| Yb | 70 | 0.985 | 23.5 | 9.92 |
| Lu | 71 | 0.977 | — | 8.33 |

^{a)}Atom percentages determined by elemental analysis.

MOFs are typically less robust than other common heterogeneous materials (e.g., metal oxides, zeolites, etc.), which has limited their widespread industrial implementation. Although thousands of MOF structures have been reported, the majority of application development in the MOF field has focused on a handful of materials that are known to be highly stable (e.g., UiO-66, MIL-101, ZIF-8, etc.). With that in mind, the thermal and aqueous stability of M-TCPB was thoroughly evaluated. Several HE-TCPB compositions (5M-, 10M-, and 15M-TCPB) were evaluated along with 5 monometallic analogues (Y-, Eu-, Gd-, Er-, and Yb-TCPB). MOF samples were soaked in liquid water for a minimum of one month in air then evaluated by PXRD. M-TCPB was found to retain a high degree of crystallinity in water regardless of composition or exposure time (up to 4 months). Many other REE-based MOFs suffer from poor water stability, demonstrating the impact of the fluorinated REE clusters in M-TCPB. Furthermore, the materials displayed decomposition temperatures beyond 500° C. under N₂ by thermogravimetric an analysis (TGA), exceeding the thermal stability of the majority of MOFs.

In order to take full advantage of heterometallic compositions, controlling the location of individual metal ions with respect to one another is of crucial importance. See R. E. Sikma et al., J. Am. Chem. Soc. 146, 5715 (2024). The distance between ions determines the extent to which they may function cooperatively and/or synergistically. As such, the formation of monometallic domains, wherein there is some segregation of metals over smaller (nm) length scales, is typically detrimental. See Z. Ji et al., Science 369, 674 (2020). Additionally, any deviation from a random, homogeneous metal distribution decreases S_{conf} with respect to the ideal value. See S. S. Aamlid et al., J. Am. Chem. Soc. 145, 5991 (2023). With these factors in mind, rigorous characterization of M-TCPB materials was undertaken to determine the degrees of metal mixing. Due to the challenges associated with interpreting spectral data for large numbers of metals, a series of 2- and 3-metal M-TCPB MOFs was synthesized containing every possible combination of Eu, Yb, and Y. These 3 metals were chosen to include two lanthanides of different sizes and Y, which is a transition metal and incorporates preferentially over other metals. These 3 elements also have distinct, non-overlapping electron binding energies, enabling characterization of the materials by X-ray photoelectron spectroscopy (XPS, vide infra). Input ratios of individual metals were equimolar in each case to maximize the degrees of potential metal mixing. Using the standard M-TCPB synthetic protocol, 4 materials were obtained: EuYb-, EuY-, YbY-, and EuYbY-TCPB. Additionally, each monometallic material corresponding to the metals in 5M-TCPB (Eu, Gd, Er, Yb, and Y) was synthesized by the same procedure. Successful synthesis of the mono-, bi-, and trimetallic M-TCPB materials was confirmed by PXRD, as shown in FIG. 1B, which indicated the formation of phase pure, isostructural materials in every case. SEM/EDX revealed homogeneous metal distributions in the bi- and trimetallic materials across the single crystal length scale, and elemental analysis confirmed that the targeted metals were incorporated in significant quantities in each case. The bi- and trimetallic MOFs followed the same compositional trend as the HEMOFs, with Y favored over the lanthanides and the smaller lanthanide (Yb) favored over Eu. Nevertheless, the metallic compositions of the materials ensured ample opportunities for metal mixing. Further characterization of the monometallic and HEMOFs by N₂ physisorption analysis at 77 K confirmed that the MOFs are highly porous regardless of composition, with BET surface areas between 1230-1580 m² g⁻¹, as shown in FIG. 1C and Table 2.

### Spectroscopic Studies

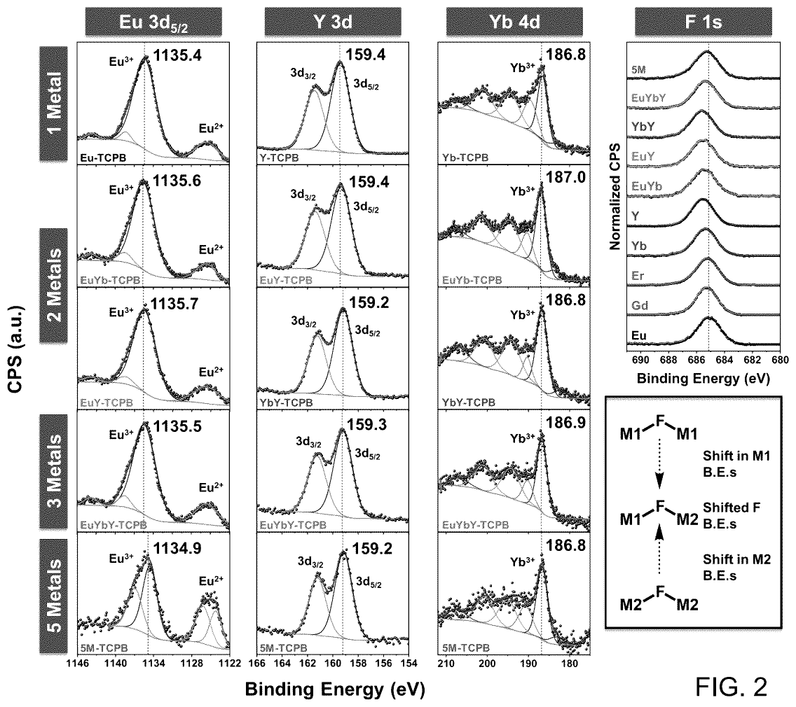

It has been demonstrated that spectroscopic techniques, including X-ray photoelectron spectroscopy (XPS) and infrared (IR) spectroscopy, can be used to distinguish between well-mixed and segregated metal distributions. See R. E. Sikma et al., J. Am. Chem. Soc. 146, 5715 (2024); Q. Liu et al., J. Am. Chem. Soc. 138, 13822 (2016); and F. Nouar et al., Chem. Commun. 48, 10237 (2012). Because XPS binding energies are sensitive to coordination environment, mixed-metal clusters are expected to display shifted XPS peaks relative to the corresponding monometallic clusters (FIG. 2, inset). See Q. Liu et al., J. Am. Chem. Soc. 138, 13822 (2016). This should be true for both the metals and any bridging ions (e.g., OH⁻, F⁻). In heterometallic MOFs, this allows the differentiation of materials with mixed-metal clusters from MOFs in which different metals are segregated into separate clusters. In order to make this determination, monometallic derivatives containing each of the metals of interest must be synthesized and analyzed in addition to the heterometallic MOF. Comparison to the single-metal standards can be used to determine whether the metal peaks are shifted in the mixed-metal material. It is important that the metals in question display non-overlapping, well resolved XPS peaks for this analysis.

XPS was used to evaluate the degrees of metal mixing in heterometallic M-TCPB materials. The mono-, bi-, and trimetallic M-TCPB MOFs containing Eu, Yb, and Y (Eu-, Yb-, Y-, EuYb-, EuY-, YbY-, and EuYbY-TCPB) were analyzed to observe the behavior of these 3 well resolved elements, and 5M-TCPB was also analyzed to observe any differences in behavior based on the HE configuration. Eu 3d, Yb 4d, and Y 3d XPS spectra were collected for the full suite of materials. Because F⁻ bridges adjacent metals in the MOF clusters, F 1s spectra were also collected for each of the materials plus Gd- and Er-TCPB, as shown in FIG. 2. Binding energies were tracked across the series to quantify peak shifts, with the envelopes used to identify peak positions.

The largest deviations were observed for Eu, which is the largest and most polarizable cation in the series, while the changes in peak positions for Yb and Y were less pronounced. Shifting of one or more metal peaks by at least ±0.2 eV was observed for each bimetallic composition, indicating the presence of mixed-metal clusters in all 3 materials. See Q. Liu et al., J. Am. Chem. Soc. 138, 13822 (2016). Each of the 3 metal peaks shifted by ˜0.1 eV in EuYbY-TCPB, also indicating intra-cluster metal mixing. The Y 3d peak of 5M-TCPB was shifted −0.2 eV relative to Y-TCPB, while the Yb 4d binding energy in 5M-TCPB was nearly identical to that of monometallic Yb-TCPB. The most significant difference in 5M-TCPB was seen in the Eu 3d binding energies. The primary peak shifted −0.5 eV relative to Eu-TCPB while also developing a pronounced shoulder. Although the origin of the shoulder is unclear, the data suggest that Eu exists primarily in heterometallic clusters. Taken together, the Eu and Y data point to high degrees of metal mixing in 5M-TCPB, while the minimal deviation of the Yb 4d peak position was consistent with other mixed-metal compositions (i.e., YbY- and EuYbY-TCPB). Importantly, the directions of the metal XPS peak shifts were correctly predicted by computational modeling of the 2-, and 3-metal heterometallic clusters, further confirming the formation of well-mixed clusters.

As expected, based on relative electronegativity values, Y-TCPB displayed the highest F 1s binding energy in the monometallic series. See C. Tantardini and A. R. Oganov, Nat. Commun. 12, 2087 (2021). Surprisingly, EuY- and YbY-TCPB gave F binding energies essentially identical to Y-TCPB, indicating a predominance of Y-F-Y motifs beyond what would be expected for a random fluoride distribution. In the case of EuY-TCPB, this may be partially attributed to the higher Y:Eu ratio (ca. 4:1). F 1s binding energies consistently decreased when moving to 3 and 5 metals, shifting to energies that were more representative of average values as the mole fraction of Y was decreased. This averaging indicates that fluoride and metal distributions become more random as the number of unique metals is increased.

Interestingly, peaks corresponding to Eu²⁺ were observed in each Eu-containing sample, despite the use of an Eu³⁺ precursor in the MOF syntheses. The Eu²⁺ peak was much more pronounced in 5M-TCPB compared to the other materials, again pointing to complex Eu environments. The presence of Eu²⁺ was posited to be a surface phenomenon and was investigated further by hard X-ray photoelectron spectroscopy (HAXPES, see below). See E. J. Cho and S. J. Oh, Phys. Rev. B 59, R15613 (1999).

One main shortcoming of XPS analysis of MOFs is the small penetration depth, which is typically less than 10 nm. This means XPS spectra only reflect the nature of species near the crystal surfaces. In order to ascertain whether the XPS spectra of these materials reflect the crystal interiors, several M-TCPB MOFs (Eu-, Yb-, Y-, and EuYbY-TCPB) were studied by hard X-ray photoelectron spectroscopy (HAXPES), which allows the collection of depth-dependent data. See C. Kalha et al., J. Phys.: Condens. Matter 33, 233001 (2021). Importantly, the spectra collected deeper in the materials matched well with the surface spectra for Y and Yb, indicating minimal depth dependence for these metals. However, the Eu 3d HAXPES spectra were a notable exception. While Eu²⁺ was clearly observed in Eu- and EuYbY-TCPB at low penetration depths, little to no Eu²⁺ was found deeper into the crystals. Thus, the formation of Eu²⁺ is ascribed to redox chemistry at the crystal surfaces, while the bulk crystals contain only Eu³⁺. See E. J. Cho and S. J. Oh, Phys. Rev. B 59, R15613 (1999). The ability of Eu³⁺ to undergo reduction to Eu²⁺ in REE cluster based MOFs has been posited previously but not unambiguously demonstrated until now. See P. R. Donnarumma et al., Cryst. Growth Des. 24, 1619 (2024).

The O—H vibrational energies of bridging hydroxide ions are sensitive to the properties of the coordinated metal ions, such that changing the metals gives a small but measurable shift in the corresponding IR peaks. In this case, M1-OH-M1 and M2-OH-M2 (M1 and M2 are generic metal ions, M1≠M2) would show O—H IR peaks at different energies, and the energy of the M1-OH-M2 δOH vibrations are expected to occur at intermediate values. See F. Nouar et al., Chem. Commun. 48, 10237 (2012). All M-TCPB materials were studied by IR, with specific attention paid to the δOH energies (ca. 845 cm⁻¹), as the vO-H bands (ca. 3750 cm⁻¹) were not well resolved enough to provide meaningful information. By comparison to the monometallic MOFs, the majority of the mixed-metal M-TCPB materials display intermediate δOH peaks, indicating intra-cluster metal mixing. The only exception is EuY-TCPB, which gave a δOH peak at an energy nearly identical to that of Eu-TCPB. This points to a predominance of Eu—OH—Eu motifs greater than that expected for a completely random distribution. XPS analysis of EuY-TCPB (above) additionally indicated an excess of Y—F—Y motifs. Although F⁻ and OH⁻ should function interchangeably in the MOF clusters, these data indicate a degree of anion segregation, wherein F⁻ preferentially coordinates to Y and OH⁻ preferentially coordinates to Eu. This necessitates some segregation of the metals as well, although the exact domain structure is unclear. Significantly, no evidence of metal or anion segregation was seen in the IR data for 5M- and 15M-TCPB.

### High Resolution STEM-EDX

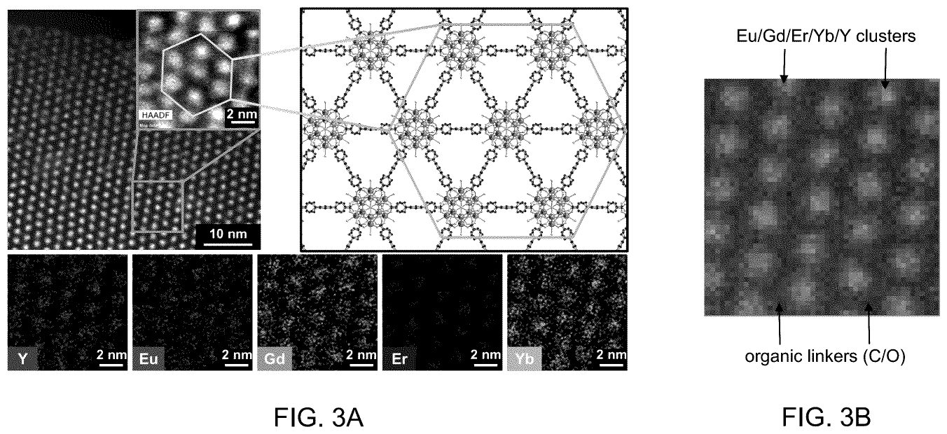

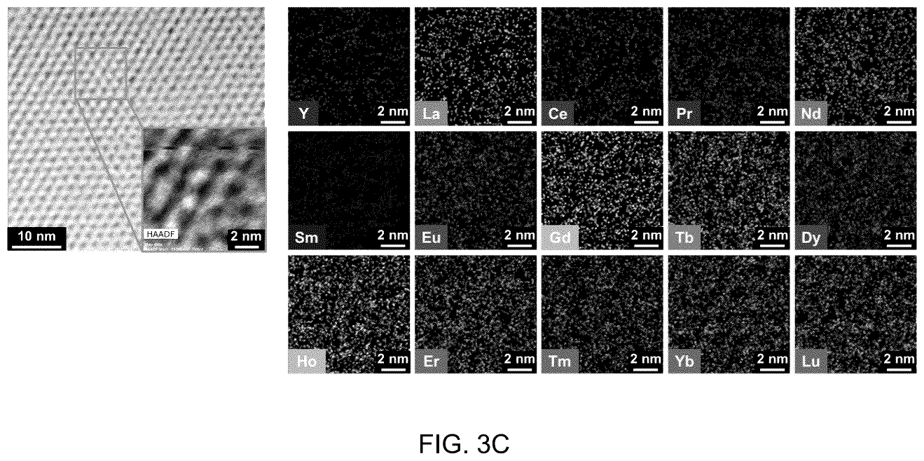

High resolution transmission and scanning transmission electron microscopy (TEM/STEM) have been used to image MOF structures on an atomic level. See L. Liu et al., Commun. Chem. 3, 99 (2020); and L. Liu et al., Nat. Chem. 11, 622 (2019). This has allowed direct visual observation of structural features, including defects and surface terminations. Additionally, STEM has been coupled with EDX to inform elemental composition across small length scales in MOFs. See J. Castells-Gil et al., Chem. 6, 3118 (2020); T. Tanasaro et al., Cryst. Growth Des. 18, 16 (2018); and X. Zhao et al., ACS Energy Lett. 3, 2520 (2018). STEM-EDX is a powerful tool that has given insight into metal mixing in other HE materials (e.g., oxides and alloys) with high resolution. See Y. Sun and S. Dai, Sci. Adv. 7, eabg1600 (2021); C. M. Rost et al., Nat. Commun. 6, 8485 (2015); and Y. Yao et al., Matter 4, 2340 (2021). However, MOFs are more susceptible to beam damage than traditional HE materials, and STEM-EDX of mixed-metal MOFs has not been reported with sufficient resolution to visualize intra-cluster metal mixing. To address this research gap, STEM-EDX analysis was performed on 5M-TCPB targeting cluster level resolution. Fortunately, a sufficiently thin MOF layer with the proper orientation was identified, and analysis yielded conclusive evidence of a well-mixed metal distribution in the material, as shown in FIG. 3A. EDX confirmed that each individual cluster that was imaged contains all 5 of the REE ions in the material. Well-defined regions of high concentration were observed for each metal, corresponding to individual nonanuclear clusters. The data for Eu was somewhat less well defined, which may be attributed to the low Eu content (11.3 mol %) relative to the other metals, but still showed a similar clustering effect. Furthermore, the data was effectively fit using machine learning with two compositional components, one for the REE clusters and one for the organic portion, confirming that each cluster has approximately the same composition, as shown in FIG. 3B. See P. G. Kotula and M. R. Keenan, Microsc. Microanal. 12, 538 (2006); and M. R. Keenan and P. G. Kotula, Appl. Surf. Sci. 231-232, 240 (2004). STEM-EDX of 15M-TCPB did not yield the complete cluster-level resolution seen for 5M-TCPB but did confirm homogeneous metal mixing over the short length scales examined, as shown in FIG. 3C.

Nevertheless, machine learning analysis was performed on two separate regions of 15M-TCPB and did indicate compositional homogeneity across the array of heterometallic clusters.

### Catalytic CO₂ Conversion

Conversion of CO₂ into value-added products is a promising method to combat the rising atmospheric concentration of CO₂, which is a primary driver of climate change. CO₂ can be used as a raw material for the production of cyclic carbonates, which are important intermediates in the synthesis of pharmaceuticals, solvents, and polycarbonates. This conversion can be achieved by reaction of CO₂ with epoxides in the presence of a Lewis acid catalyst, typically with a halide source as a co-catalyst to facilitate epoxide ring-opening. Many efficient catalysts for these transformations are known, but MOFs have emerged as some of the most promising candidates. Many MOFs display potential open metal sites (i.e., bound solvent molecules that can be readily removed) on their inorganic building units, which can serve as catalytic sites for CO₂ epoxidation. MOFs constructed using strong Lewis acids, such as Zr(IV), are some of the most efficient examples. However, elevated temperatures and pressures and/or long reaction times are often needed to achieve significant conversion. See F. Guo and X. Zhang, Dalton Trans. 49, 9935 (2020); L. Jin et al., Chem. Eur. J. 27, 14947 (2021); L.-G. Ding et al., Inorg. Chem. 56, 2337 (2017); and V. Guillerm et al., Nat. Chem. 6, 673 (2014).

HEMOFs may prove to be superior heterogeneous catalysts due to their unique electronic structures and structural flexibility. The high degree of metal mixing in various M-TCPB compositions also maximizes the opportunities for different metals to function synergistically and/or cooperatively. REE ions can function effectively as Lewis acid catalysts, and the predominance of potential open metal sites (i.e., terminal H₂O ligands) on the 9-metal clusters in M-TCPB should yield high catalytic activity. See K. Suzuki et al., Inorg. Chem. 51, 6953 (2012). However, MOFs based on polynuclear REE clusters have only rarely been used as Lewis acid catalysts. See V. Guillerm et al., Nat. Chem. 6, 673 (2014).

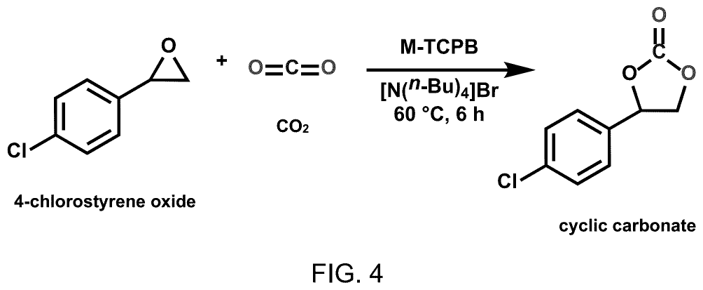

With these considerations in mind, 5M- and 15M-TCPB were evaluated as heterogeneous catalysts for the cycloaddition of CO₂ with 4-chlorostyrene oxide under mild conditions (1 atm CO₂, 60° C.; FIG. 4). Although it is not commonly used as a model substrate for CO₂ cycloaddition reactions, 4-chlorostyrene oxide displays lower toxicity than many other epoxides and is less volatile, making it more straightforward to work with. Importantly, the pores in M-TCPB are sufficiently large to accommodate this bulkier reagent. However, a variety of epoxides can be used, including propylene oxide, epichlorohydrin, divinylbenzene dioxide, styrene oxide, and derivatives thereof.

To perform the CO₂ epoxidation, M-TCPB and tetrabutylammonium bromide (TBA-Br) were added to a 10 mL Schlenk flask under inert atmosphere, then 4-chlorostyrene oxide was added as a neat liquid. The headspace of the flask was flushed with CO₂ then sealed under a CO₂ balloon, giving a pressure of ˜1 atm. The reaction was heated to 60° C. for 6 h and the reaction products were quantified by ¹H NMR, with hexamethylbenzene (HMB) used as an internal standard. Similar to many other systems, TBA-Br was used as a co-catalyst to facilitate the catalytic cycle. The reaction time was deliberately chosen targeting <100% conversion (ca. 70%) in order to better evaluate the differences in reactivity between different M-TCPB compositions. In addition to the HEMOFs, the 5 monometallic materials (Eu-, Gd-, Er-, Yb-, and Y-TCPB) and EuYbY-TCPB were assessed in order to correlate composition with reactivity. The results of the catalytic testing are presented in Table 2.

TABLE 2

| Conversion percentages for cycloaddition of CO₂ with 4- | | | |
|---|---|---|---|
| chlorostyrene oxide catalyzed by M-TCPB with | | | |
| varying metal compositions and | | | |
| associated control and benchmark reactions, | | | |
| with N₂ BET surface areas of the | | | |
| materials included for reference. | | | |
| | SBET | | Conv. |
| MOF | (m² g⁻¹) | Time (h) | (%)^{d)} |
| Eu-TCPB^{a)} | 1460 | 6 | 66 |
| Yb-TCPB^{a)} | 1380 | 6 | 72 |
| Y-TCPB^{a)} | 1580 | 6 | 73 |
| Gd-TCPB^{a)} | 1380 | 6 | 65 |
| Er-TCPB^{a)} | 1280 | 6 | 68 |
| EuYbY-TCPB^{a)} | n.d.^{c)} | 6 | 70 |
| 5M-TCPB^{a)} | 1520 | 6 | 69 |
| 5M-TCPB^{a)} | 1520 | 18 | 94 |
| 15M-TCPB^{a)} | 1360 | 6 | 72 |
| 15M-TCPB^{a)} | 1360 | 18 | 90 |
| SiO₂/Al₂O₃ | 216 | 6 | 26 |
| zeolite^{a)} | | | |
| Y-zeolite^{a)} | n.d.^{c)} | 6 | 32 |
| MOF-808^{a)} | 1680 | 6 | 57 |
| UiO-66^{a)} | 1390 | 6 | 56 |
| None^{b)} | - | 6 | 25 |
| None^{b)} | - | 18 | 44 |

^{a)}1.0 mmol epoxide, 0.10 eq. TBA-Br, 0.05 eq. MOF (per metal ion), heated to 60° C. for indicated time under balloon pressure CO₂.
^{b)}Identical conditions with no MOF added.
^{c)}BET surface area was not determined.
^{d)}Determined by ¹H NMR with reference to HMB internal standard.

Despite the mild conditions and relatively short reaction time, all M-TCPB compositions gave ≥65% conversion after 6 hours. Of the monometallic compositions, Y-TCPB gave the highest 6 h conversion at 73%. Among the lanthanides, conversion roughly trended with ionic radius (Table 1), with Yb-(72%) and Er-TCPB (68%) giving higher conversion than Eu-(66%) and Gd-TCPB (65%). This trend can be explained by the stronger Lewis acidity of the smaller (harder) ions. EuYbY-TCPB (70%) and 5M-TCPB (69%) both displayed intermediate performance, closely agreeing with the average activity of the metal components. Interestingly, 15M-TCPB (72% conversion) showed enhanced activity relative to 5M-TCPB, making it one of the most active compositions. Of the metals in 15M-TCPB, the 14 lanthanides are either known or expected to have lower activity than Y, so the near-equal conversions for Y- and 15M-TCPB provide preliminary evidence of a synergistic effect in the 15-metal material. 5- and 15M-TCPB were also evaluated over an 18 h timeframe, with the longer reaction time giving near-complete conversion.

M-TCPB significantly outperformed commercial zeolites, which are more traditional porous materials that are used as catalysts in industrial processes. The conversion for silica-alumina zeolite was essentially on par with the control reaction with no heterogeneous catalyst, while the conversion for Y-zeolite was only slightly higher (32%). The results were further benchmarked by comparison to two well-known Zr(IV) MOFs, MOF-808 and UiO-66, under identical reaction conditions. Although Zr-MOFs have been widely studied as Lewis acid catalysts, both UiO-66 and MOF-808 gave substantially lower conversion (56-57%) than the entire series of M-TCPB materials. Based on these benchmarks and literature examples, M-TCPB is a superior catalyst for CO₂ epoxidation, achieving high conversion under mild conditions and short timeframes. This can be partially rationalized by the abundance of potential open metal sites on the nonanuclear REE clusters in M-TCPB. Importantly, catalytic activity was found to be composition dependent, and the ability to incorporate any number of REE metals into the M-TCPB framework will facilitate further optimization.

### Computational Modeling

The ability to homogeneously integrate up to 15 metals into a single MOF opens up a near-limitless design space in which important properties are directly dependent upon the tunable electronic structures of the materials. In particular, electronic density-of-states (DOS) calculations can give invaluable insight into material properties, including catalytic activity, band structure, conductivity, and optical properties. When applied to hypothetical materials, computational screening can accelerate the discovery of new materials for important applications. This is especially valuable when working in vast design spaces with countless possibilities, such as the compositional space offered by HEMs. Computational methods will therefore be vital to the continued development of the HEM field.

DFT calculations can give a detailed understanding of the DOS in materials, but these calculations are hindered by large numbers of atoms. In order to be viable for complex materials, DFT can be performed on representative models containing the smallest possible number of atoms. In MOFs, this is often accomplished by modeling the inorganic building unit as a discrete molecular cluster, which can serve as an excellent proxy to understand the properties of the extended materials. Previous work has shown unique optical responses to adsorption of specific molecular species in monometallic RE MOFs and photocontrol via charge transfer pathways in trimetallic RE MOFs. See D. J. Vogel et al., Phys. Chem. Chem. Phys. 21, 23085 (2019); and J. I. Deneff et al., Nat. Commun. 14, 981 (2023). With these previous results providing the groundwork, DFT calculations were employed to gain further insight into the unique electronic environments in heterometallic M-TCPB materials as a function of composition, including high-entropy 5M-TCPB. Although up to 15 metals can be incorporated into one M-TCPB material, the number of metals was capped at 5 for computational feasibility.

The models were built as nonanuclear clusters analogous to those in M-TCPB with twelve terminal formate ligands in place of the linker-based carboxylates. The two central μ₃-bridging ligands were modeled as O₂₋ and the other twelve μ₃-bridging ligands were modeled as F⁻, although there is some disordered mixing of OH⁻ and F⁻ in the material. The nine terminal ligands were modeled as H₂O, giving the cluster an overall −1 charge. Model clusters were built containing mono-, bi-, and trimetallic combinations of Eu, Yb, and Y, matching the compositions used for XPS analysis, as well as 5M-TCPB, as shown in Table 3. The monometallic clusters were modeled to provide valuable baseline information about the electronic structures of M-TCPB MOFs, while heterometallic clusters were investigated to give additional insight into the effects of compositional variation. The metal ratios were maintained at or near equimolar, with the experimentally determined molar percentages used to determine which elements should be in slight excess as dictated by the odd number of metal ions (9). The metal sites were randomly populated for each composition to give arrangements that should be favored by direct heterometallic synthesis. It is important to note that experimental evidence unequivocally demonstrated incorporation of all 5 metals into each REE cluster in 5M-TCPB (vide supra), validating the use of a single-cluster model.

TABLE 3
Numbers of REE atoms per cluster in single-cluster
computational models of M-TCPB MOFs.

| MOF | Y (#) | Eu (#) | Gd (#) | Er (#) | Yb (#) |
|---|---|---|---|---|---|
| 5M-TCPB | 2 | 1 | 2 | 2 | 2 |
| EuYbY-TCPB | 3 | 3 | — | — | 3 |
| EuYb-TCPB | — | 4 | — | — | 5 |
| EuY-TCPB | 5 | 4 | — | — | — |
| YbY-TCPB | 4 | — | — | — | 5 |
| Eu-TCPB | — | 9 | — | — | — |
| Yb-TCPB | — | — | — | — | 9 |
| Y-TCPB | 9 | — | — | — | — |

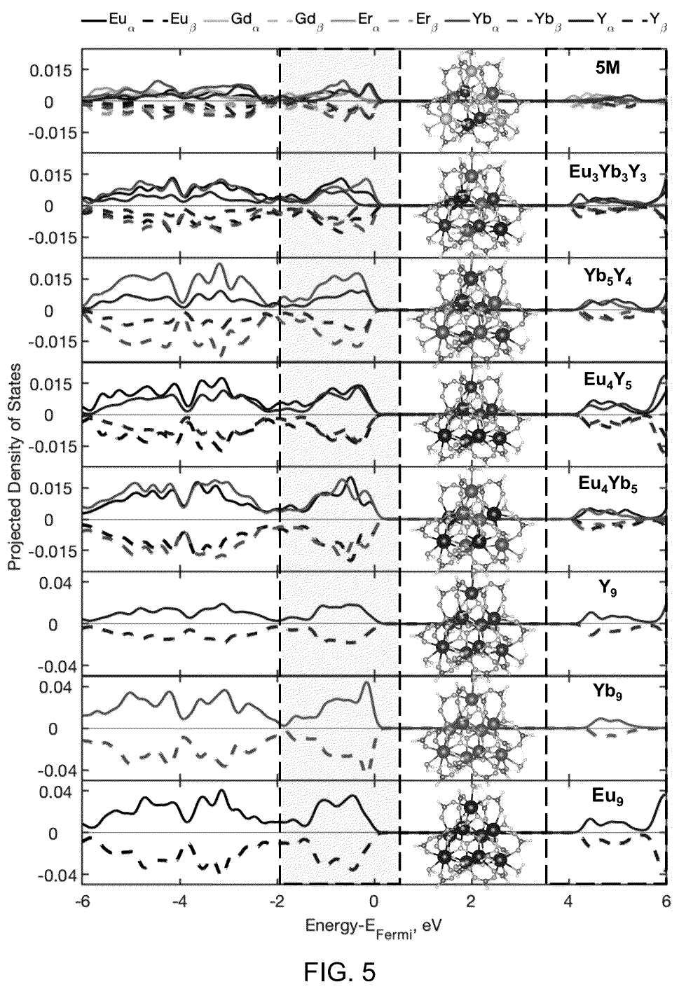

To analyze the electronic structure environments in mono- and heterometallic RE MOFs, calculated projected densities-of-states (PDOS) were visualized to show individual metal contributions to the total electronic structures, as shown in FIG. 5. This type of analysis was previously used to understand the importance of metal ratios and positioning on the electronic structures of bimetallic actinide MOFs. See K. C. Park et al., Angew. Chem., Int. Ed. 62, e202216349 (2023). The contribution of Ln 4f orbitals to chemical bonds and interactions are generally minimal, with the largest change to the metal PDOS occurring in the 4d orbitals. See O. Ordoñez et al., Inorg. Chem. 61, 15138 (2022). With that in mind, the PDOS in FIG. 5 represent only the total d-orbital electron densities localized on the RE metal elements as a function of energy, with total DOS and further discussion available in the supporting information.

In comparing mono- vs heterometallic PDOS, a number of interesting trends become apparent. Individual PDOS for monometallic Eu, Yb, and Y clusters show similar features, with Yb presenting a stronger peak near the valence band edge (VBE, FIG. 5, central shaded region) and a reduced conduction band edge (CBE, FIG. 5, right shaded region) compared to both Y and Eu. However, the relative behaviors of Eu, Yb, and Y change upon incorporation into bimetallic clusters. In Eu₄Yb₅, Eu and Yb give relatively equivalent contributions to the PDOS at both the VBE and CBE, and the peak amplitudes for both elements are reshaped near −0.13 eV and −0.6 eV. Similarly, Eu and Y contribute essentially equally to the PDOS in the Eu₄Y₅ model, with the monometallic amplitude patterns largely conserved in this case. On the other hand, while the CBE of Yb₅Y₄ receives approximately equal contributions from Yb and Y, the VBE is dominated by Yb, which also shows moderate delocalization near the VBE. Interestingly, the trimetallic cluster (Y₃Yb₃Eu₃) shows different changes in relative PDOS between the three metal species. Yb remains the primary contributor to the VBE while Eu shifts density to its second peak in the VB at −0.67 eV. The most notable change occurs in the PDOS of Y, which shifts −0.3 eV below the Fermi energy in the VB while nonetheless contributing significantly to the CBE. Notably, the Y states shift to energies better correlated with localization on the organic linkers, which could be important for optical absorption and charge transfer events.

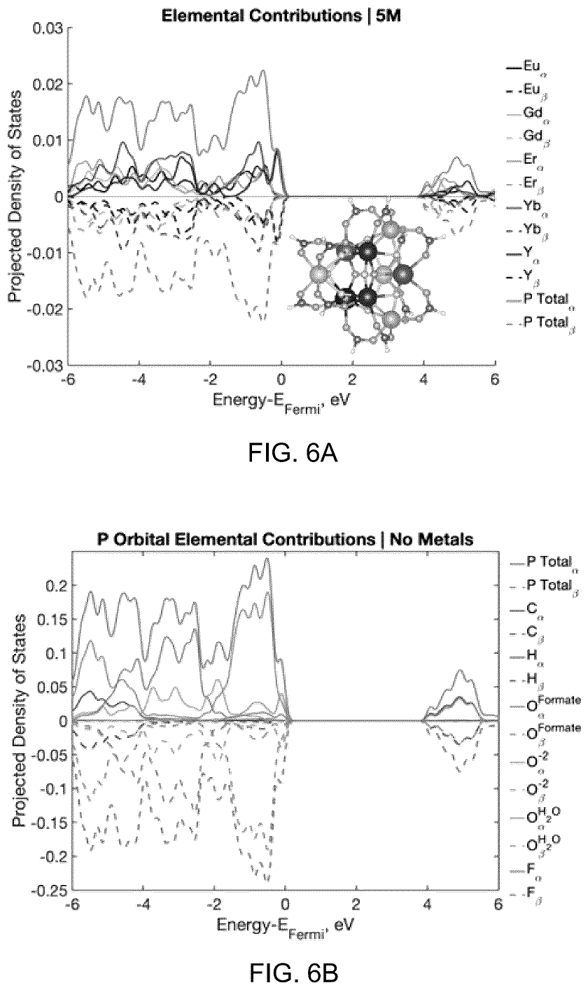

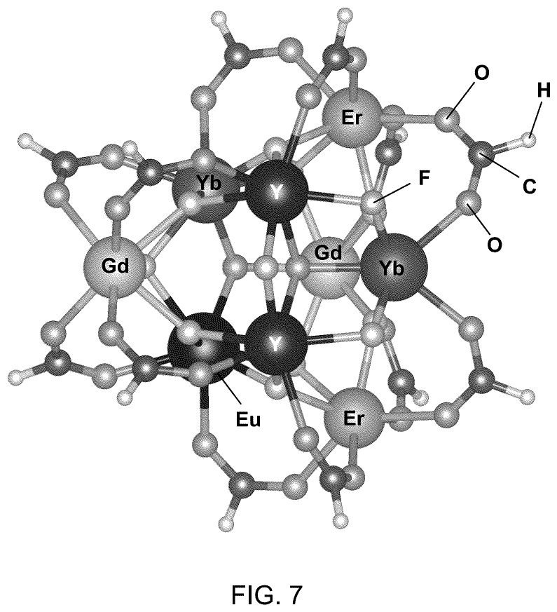

The intermetallic effects are also pronounced in the 5M model cluster (FIG. 5, FIG. 6A, FIG. 7), which includes Y, Eu, Gd, Er, and Yb. By comparison to the EuYbY cluster, inclusion of Er and Gd results in additional relative energy shifts within the electronic structure (FIGS. 5 and 6A). The VBE of the 5M cluster is dominated by contributions from Yb and Y, while Eu, Gd, and Er are shifted below the Fermi level by 0.25 eV. This is in direct contrast to the behavior of Y in the EuYbY model, which shifts below the Fermi level and gives essentially no contribution to the VBE. Shifting of specific metals into the VB and away from the Fermi level is only seen in the 3- and 5-metal systems, demonstrating the fine control over electronic structure that is offered by multi-metallic compositions. The CBE of the 5M cluster receives contributions from all 5 elements but is largely localized on Er at 4.07 eV, with Er amplitudes ˜3.5x-17x higher than the other metals. Interestingly, the opposite is seen for the second peak in the CB (˜4.8 eV), with Er having the lowest contribution of all 5 metals and considerable localization seen on Gd. The contributions of Eu, Yb, and Y become more significant at higher CB energies, with Eu generally being the least prominent of the three.

The shifts and relative localization of electron density of the metal species (e.g., FIG. 5) are important when considering multiple physical and chemical processes that occur within RE MOF materials, including photophysics, charge transfer and transport mechanisms, chemical adsorption, and catalytic reactivity. See M. S. Khan et al., Nanoscale Adv. 5, 6318 (2023); M. A. Syzgantseva et al., J. Am. Chem. Soc. 141, 6271 (2019); and Y. Cho and H. J. Kulik, J. Chem. Phys. 160. 154101 (2024). However, when considering the total DOS for 5M-TCPB, the localization on the RE metals is relatively low compared to the p-orbital contributions from O, F, and C, which comprise the formate, H₂O, O²⁻, and F⁻ ligands (FIG. 6A). The total p-orbital DOS in FIG. 6A has been normalized at the VBE for ease of visualization and otherwise dwarfs the metal contributions. Oxygen atoms from the formate and O²⁻ ligands contribute significantly to the total p-orbital DOS in the VB, which is unsurprising given the important role of occupied O p-orbitals in forming the metal-ligand coordination bonds that comprise the cluster, and the VBE largely resides on the central O²⁻ ligands. The two metals that contribute to the VBE are Yb and Y, which form more bonds to the O²⁻ ligands (2) than the other metals. This further demonstrates the importance of the central O²⁻ to the localization of the VBE, which corresponds with the location of the highest occupied molecular orbital (HOMO). Conversely, d-orbitals on the metals with fewer bonds to O²⁻ (Eu, Gd, and Er) and p-orbitals from the formate atoms are the primary components of the CBE. Eu, Gd, and Er also begin to contribute lower in the VB, with a corresponding increase in the O DOS below the VBE. The resonance in energy between O and the metal species indicates possible pathways for metal-to-ligand or ligand-to-metal charge transfer events, which are tunable through variation of metal species and ratios. These factors will also have a considerable impact on catalytic events and processes.

Ultimately, these computational results reveal the importance of compositional control in HEMOF clusters, as more complex compositions (i.e., larger numbers of metals) display unique energy shifts in their electronic structures with respect to the simpler mono- and bimetallic systems. Adsorption and catalysis are expected to take place at active metal sites within the MOFs, which will directly impact the local electronic structure of the participating metals. Because different metal species comprise the VBE and CBE, chemical events taking place at specific metal centers may result in easily differentiated observations. The detailed computational analysis performed here can serve as a foundation to further resolve the impacts of metal compositions and distributions on experimental properties, which can then be applied to intelligently design the next generation of high-performance HEMOFs.

The present invention has been described as high-entropy metal-organic frameworks. It will be understood that the above description is merely illustrative of the applications of the principles of the present invention, the scope of which is to be determined by the claims viewed in light of the specification. Other variants and modifications of the invention will be apparent to those of skill in the art.

1. A high-entropy metal-organic framework, comprising a plurality of polynuclear metal clusters, each polynuclear metal cluster comprising five or more rare-earth metals; wherein the rare-earth metals are present in the high-entropy metal-organic framework in approximately equimolar ratios according to −Σxᵢ ln(xᵢ)≥1.5, where xᵢ is the mole fraction of each rare-earth metal i relative to a total rare-earth metal content; and wherein the plurality of polynuclear metal clusters are connected by carboxylic acid-based linkers.

2. The high-entropy metal-organic framework of claim 1, wherein the carboxylic acid comprises a di-, tri-, tetra-, or hexacarboxylic acid.

3. The high-entropy metal-organic framework of claim 1, wherein the polynuclear metal cluster comprises a hexanuclear or a nonanuclear metal cluster.

4. A method for the catalytic conversion of carbon dioxide, comprising reacting carbon dioxide with an epoxide in the presence of a high-entropy metal-organic framework catalyst, thereby yielding a cyclic carbonate as a reaction product.

5. The method of claim 4, wherein the epoxide comprises a propylene oxide, epichlorohydrin, divinylbenzene dioxide, styrene oxide, or a derivative thereof.

6. The method of claim 4, further comprising a halide source as a co-catalyst to facilitate epoxide ring-opening.

7. The method of claim 4, wherein the high-entropy metal-organic framework catalyst comprises a plurality of polynuclear metal clusters, each polynuclear metal cluster comprising five or more rare-earth metals; wherein the rare-earth metals are present in the high-entropy metal-organic framework in approximately equimolar ratios according to −Σxᵢ ln(xᵢ)≥1.5, where xᵢ is the mole fraction of each rare-earth metal i relative to a total rare-earth metal content; and wherein the plurality of polynuclear metal clusters are connected by carboxylic acid-based linkers.
